(19) United States
(12) Patent Application Publication
(10) Pub. No.: US 2007/0092547 A1
(43) Pub. Date: Apr. 26, 2007

(54) Method for treating/controlling/killing fungi and bacteria

(76) Inventors: Jay E. Birnbaum, Montville, NJ (US); Thomas Blake, Budd Lake, NJ (US); Mahmoud Ghannoum, Hudson, OH (US); Steven Vallespir, Princeton, NJ (US); Mark David Antonacci, Randolph, NJ (US); Michael Patrick Ryan, Mendham, NJ (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/541,822

(22) Filed: Oct. 2, 2006

Related U.S. Application Data
(60) Provisional application No. 60/729,624, filed on Oct. 24, 2005.

(51) Int. Cl. A01N 25/00; A01N 65/00

(52) U.S. Cl. 424/405; 424/750; 424/769; 424/778

(57) ABSTRACT

This present teaching describes how to treat substrates with novel compositions in order to limit fungi, dermatophytes, yeasts, and bacteria thereon.

### CROSS-REFERENCE TO RELATED APPLICATIONS

This application claims priority from U.S. Provisional Application Ser. No. 60/729,624 filed on Oct. 24, 2005, which is incorporated herein by reference in its entirety.

### INCORPORATION-BY-REFERENCE OF MATERIAL SUBMITTED ON A COMPACT DISC

Not Applicable.

### FIELD

The present teachings relate to methods for treating/preventing fungi and bacteria on substrates.

### INTRODUCTION

Fungi are responsible for a broad range of diseases of the epidermis of people and animals, including companion animals and pets.

The current invention involves a method, and compositions for the prevention and reduction of fungal diseases in man and animals, including companion animals and pets by treating a substrate with at least one antifungal compound. Such treatment may lead to decontamination of the substrate.

### SUMMARY

The present teachings include methods for treating a substrate that, directly or indirectly, contacts an epidermis including: a) treating the substrate with a first antifungal or antibacterial compound, and/or b) treating the substrate with a second antifungal or antibacterial compound, and/or treating the substrate with a third antifungal or antibacterial compound.

Provided herein are newly discovered properties of compounds which include antibacterial, antifungal, and sporicidal properties. Also novel are the combinations of compounds which lead to unexpected results in the treatment and pre-treatment of substrates against common fungi, dermatophytes, spores, and bacteria. The inventors show for the first time that combining naturally occurring fungicides with known fungicides leads to unexpectedly good results and they also show that uses of naturally occurring compounds (including fungicidal compounds), and for the first time, expands their utility against bacteria.

Provided herein are also compounds which exhibit both antifungal and antibacterial properties. Such a compound, or mixture, is particularly useful as it creates a treatment, or pre-treatment, that gives both fungal disinfectant and deodorant qualities to substrates (including but not limited to shoes).

In a further aspect of the method the antifungal compound(s) are applied in a single application (e.g. as a mixture) or in separate applications that are done serially, simultaneously, and some mixture thereof. A mixture is particularly useful as it can include several compounds which have different activities which can act synergistically. A mixture is applied “simultaneously”, namely all compounds in the mixture are applied at the same time.

In a further aspect the invention includes a method for treating a substrate with an antifungal compound via a delivery method.

The inventors have also discovered that certain antifungal compounds have antibacterial, as well as antifungal, activity. The use of these compounds in treatment either alone or in combination with other antifungal compounds will lead to inhibition of bacterial and fungal growth on a substrate.

In another aspect the current invention includes a method of decreasing the LD50 (Lethal Dose 50) of a compound with antifungal properties by combining said antifungal with a second compound wherein said second compound may, or may not be, a naturally occurring antifungal compound, synthetic, semi-synthetic, pro-drug, salt, etc.

These and other features, aspects and advantages of the present teachings will become better understood with reference to a following description, examples and appended claims.

### DRAWINGS

FIG. 1. Pre-treatment assay: (A) Active agents showed a clearance zone (arrow) around the biopsy disc, while (B) inactive agents showed fungal growth around the disc. Post treatment assay: (C) Discs treated with active agents showed no fungal growth. (D) Inactive agents showed fungal growth on discs.

FIG. 2. (A) CVS Double Air Foam Insole, (B) Odor eater insoles, (C) CVS Odor Stop Insoles, (D) Dr Scholl's Air Pillow Insoles. (E) Control. Dr. Scholl's insoles did not inhibit fungal growth.

FIG. 3. Effect of 30% isopropanol on Trichophyton mentagrophytes growth on (A) leather and (B) Dr. Scholl's insole. Isopropanol did not inhibit fungal growth.

FIG. 4. Effect of pretreatment of insoles (A) or leather (B) biopsy discs with different agents on growth of dermatophytes. Zone diameter indicates zone of clearance.

FIG. 5. Effect of pretreatment of insoles with (A) 1% terbinafine, (B) 1% tolnaftate, or (C) 1% tea tree oil

FIG. 6. Effect of acetone on the activity of tolnaftate against dermatophyte growth. (A) Growth of T. mentagrophytes on insole disc pretreated with (A) acetone or (B) 4% tolnaftate (w/v, prepared in acetone). (C) Activity of 4% tolnaftate (dissolved in acetone) on already established contamination of T. mentagrophytes. (no fungal regrowth was observed).

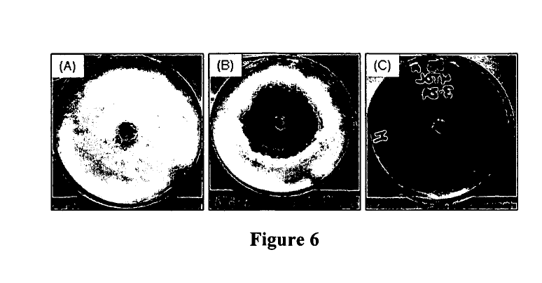

FIG. 7. Effect of post-infection treatment of insole (A) or leather (B) biopsy discs with different agents on dermatophyte growth. Zone diameter indicates zone of growth. Treatment with 30% isopropanol served as vehicle control.

FIG. 8. Scanning electron microscopy (SEM) analyses of insoles infected with T. mentagrophytes. Magnification ×2000 for all panels. Bar represents 20 μM for panels A through F, while it represents 10 μM for the post-infected treated discs (Panels G-I).

FIG. 9. Scanning electron microscopy (SEM) analyses of leather biopsies infected with T. mentagrophytes. Magnification ×2000; bar-20 μm.

FIG. 10. FIG. 10A. Effect of pretreatment of insoles with (A) 0.01% tolnaftate, (B) 3% tea tree oil, or (C) 0.01% tolnaftate +3% tea tree oil on T. rubrum growth on shoe insoles. FIG. 10B. Effect of post-treatment of infected insoles with (A) 0.01% tolnaftate, (B) 3% tea tree oil, or (C) 0.01% tolnaftate +3% tea tree oil on T. rubrum growth.

### DETAILED DESCRIPTION

Abbreviations and Definitions

BOTANICAL: A botanical is a compound isolated from a plant. Botanical antifungal compounds can be isolated from, for example, Ocimum basilicum (Basil), Cinnamomum aromaticum var. Cassia (Cinnamon), Cedrus libani (Cedar of Lebanon), any Cedrus spp., Chamaemelum nobile (Chamomile), Cymbopogon nardus (Citronella), Syzygium aromaticum (Clove & clove bud), Cuminum cyminum(Cumin), Foeniculum vulgare (Fennel), Melaleuca altemfolia (Tea Tree), Mentha x piperita (Peppermint), Mentha spicata (Spearmint), Curcuma longa (Tumeric), Cymbopogon citratus (Lemongrass), Santalum album (Sandalwood), as well as other compounds isolated from plants that have antifungal properties.

NATURAL ANTIFUNGAL COMPOUND: A natural antifungal compound (or naturally occurring antifungal compound) is a compound isolated from a botanical source (see botanical antifungal compound) or other naturally occurring source (e.g. saliva, amphibian skin, invertebrates (e.g. worms)). These compounds can be proteins (enzymes) or other products produced by animals or plants.

FUNGUS: Any of numerous eukaryotic organisms of the kingdom Fungi, which lack chlorophyll and vascular tissue and range in form from a single cell (e.g., yeast) to a body of mass branched filamentous hyphae that often produce specialized fruiting bodies and pseudohyphae. The kingdom includes, but is not limited to, the yeasts, filamentous molds, dermatophytes, smuts, and mushrooms.

ANTIFUNGAL COMPOUND is defined as any chemical or substance that has the ability to inhibit the growth of fungi, and/or kill fungal cells/spores. Compound as used throughout this application includes salts and pro-drugs of the compound.
Included in the definition of ANTIFUNGAL COMPOUNDS are substances that possess static (e.g. inhibitory) activity (FUNGISTATIC COMPOUNDS) and/or cidal (e.g. killing) activity (FUNGICIDAL COMPOUNDS) against fungal cells (vegetative and spore structures).
Also included in the definition of ANTIFUNGAL COMPOUND is any substance that is synthetic, semisynthetic or natural in origin that possesses antifungal activity as defined.
Also included in the definition of ANTIFUNGAL COMPOUND is any substance that can destroy/kill/inhibit the growth of fungal spores, for example, any substance that possesses a sporistatic (inhibitory) or sporicidal (killing) activity. See definition of Sporicidal compound below.
Throughout this document the term ANTIFUNGAL COMPOUND will be an all encompassing term referring to any substance (synthetic, semisynthetic, salt, pro-drug, natural, etc.) with antifungal activity, including, inhibitory, killing, static, cidal, sporistatic or sporicidal activity. These compounds can in turn be mixed with, for example, other antifungal compounds, detergents, and/or inactive ingredients to create formulations.

SPORE: A spore is a fungus in its dormant, protected state. It has a small, usually single-celled reproductive body that is highly resistant to desiccation and heat and is capable of growing into a new organism, produced especially by certain bacteria, fungi, algae, and non-flowering plants.

SPORICIDAL COMPOUND: a substance that either inhibits the growth of, increase the susceptibility of and/or destroys fungal spores. These can be synthetic or naturally occurring. Activating spores allows fungicides that only kill or inactivate actively growing fungi to kill those spores activated. This can be used, for example, in a mixture wherein a chemical(s) that activates growth is mixed with a chemical fungicide(s). It is also possible to use at least an activating compound alone, followed by at least a fungicide, serially. Activating spores is a method known in the art for bacterial spores, for example in U.S. Pat. No. 6,656,919, which is herein incorporated by reference.

BACTERICIDAL COMPOUND: a substance that either inhibits the growth of, increases the susceptibility of and/or destroys bacteria or bacteria spores. These can be synthetic or naturally occurring. Activating spores allows bactericides that only kill or inactivate actively growing bacteria to kill those spores activated. This can be used, for example, in a mixture wherein a chemical (s) that activates growth is mixed with a chemical fungicide(s). It is also possible to use at least an activating compound alone, followed by at least a fungicide, serially. Activating spores is a method known in the art for bacterial spores, for example in U.S. Pat. No. 6,656,919, which is herein incorporated by reference.

EPIDERMIS: The outer, protective, nonvascular layer of the skin of vertebrates, covering the dermis, it serves as the major barrier function of skin and is devoted to production of a cornified layer of the skin. Epidermally derived structures include hair (and fur), claws, nails, and hooves.

TREATING: Treating a substrate means to contact the substrate with a substance. This can include, but is not limited to, the delivery methods discussed below. A liquid or powder can include, for example, at least one fungicide. The treatment can result in disinfecting the surface, but need not completely disinfect the surface. Pretreatment means to treat the substrate (or the materials used to create the substrate) prior to its use by the end user (e.g. consumer or producer of products or materials).

MINIMAL INHIBITORY CONCENTRATION (MIC): Minimal inhibitory Concentration (MIC) is described, for instance, in Clin Infect Dis. 1997 February; 24(2):235-47. Tests for antifungal activity are the MIC (Minimum Inhibitory Concentration) and MFC (Minimum Fungicidal Concentration) assays. These assays are used to determine the smallest amount of drug needed to inhibit (MIC) or kill (MFC) the fungus.

ANTIFUNGAL COMPOUNDS: Examples of antifungal compounds can be selected from the following chemical classes, or chemicals below, or naturally occurring compounds: aliphatic nitrogen compounds, amide compounds, acylamino acid compounds, allylamine compounds, anilide compounds, benzanilide compounds, benzylamine compounds, furanilide compounds, sulfonanilide compounds, benzamide compounds, furamide compounds, phenylsulfamide compounds, sulfonamide compounds, valinamide compounds, antibiotic compounds, strobilurin compounds, aromatic compounds, benzimidazole compounds, benzimidazole precursor compounds, benzothiazole compounds, bridged diphenyl compounds, carbamate compounds, benzimidazolylcarbamate compounds, carbanilate compounds, conazole compounds, conazole compounds (imidazoles), conazole compounds (triazoles), copper compounds, dicarboximide compounds, dichlorophenyl dicarboximide compounds, phthalimide compounds, dinitrophenol compounds, dithiocarbamate compounds, cyclic dithiocarbamate compounds, polymeric dithiocarbamate compounds, imidazole compounds, inorganic compounds, mercury compounds, inorganic mercury compounds, organomercury compounds, morpholine compounds, organophosphorus compounds, organotin compounds, oxathiin compounds, oxazole compounds, polyene compounds, polysulfide compounds, pyrazole compounds, pyridine compounds, pyrimidine compounds, pyrrole compounds, quinoline compounds, quinone compounds, quinoxaline compounds, thiocarbamate compounds, thiazole compounds, thiophene compounds, triazine compounds, triazole compounds, and urea compounds.

ANTIFUNGAL COMPOUNDS include the specific compounds amorolfine (dimethylmorpholine), bifonazole, butenafine, butoconazole, clioquinol, ciclopirox olamine, clotrimazole, econazole, fluconazole, griseofulvin, haloprogen, iodochlorhydroxyquine, itraconazole, ketoconazole, miconazole, naftifine, oxiconazole, povidone-iodine sertaconazole, sulconazole, terbinafine, terconazole, tioconazole, tolnaftate, undecylenic acid and its salts (calcium, copper, and zinc), voriconazole, the sodium or zinc salts of proprionic acid, butylamine, cymoxanil, dodicin, dodine, guazatine, iminoctadine, carpropamid, chloraniformethan, cyflufenamid, diclocymet, ethaboxam, fenoxanil, flumetover, furametpyr, mandipropamid, penthiopyrad, prochloraz, quinazamid, silthiofam, triforine, benalaxyl, benalaxyl-M, furalaxyl, metalaxyl, metalaxyl-M, pefurazoate, benalaxyl, benalaxyl-M, boscalid, carboxin, fenhexamid, metalaxyl, metalaxyl-M, metsulfovax, ofurace, oxadixyl, oxycarboxin, pyracarbolid, thifluzamide, tiadinil, benodanil, flutolanil, mebenil, mepronil, salicylanilide, tecloftalam, fenfuram, furalaxyl, furcarbanil, methfuroxam, flusulfamide, benzohydroxamic acid, fluopicolide, tioxymid, trichlamide, zarilamid, zoxamide, cyclafuramid, furmecyclox, dichlofluanid, tolylfluanid, amisulbrom, cyazofamid, benthiavalicarb, iprovalicarb, aureofungin, blasticidin-S, cycloheximide, griseofulvin, kasugamycin, natamycin, polyoxins, polyoxorim, streptomycin, validamycin, azoxystrobin, dimoxystrobin, fluoxastrobin, kresoxim-methyl, metominostrobin, orysastrobin, picoxystrobin, pyraclostrobin, trifloxystrobin, biphenyl, chlorodinitronaphthalene, chloroneb, chlorothalonil, cresol, dicloran, hexachlorobenzene, pentachlorophenol, quintozene, sodium pentachlorophenoxide, tecnazene, benomyl, carbendazim, chlorfenazole, cypendazole, debacarb, fuberidazole, mecarbinzid, rabenzazole, thiabendazole, furophanate, thiophanate, thiophanate-methyl, bentaluron, chlobenthiazone, TCMTB, bithionol, dichlorophen, diphenylamine, benthiavalicarb, furophanate, iprovalicarb, propamocarb, thiophanate, thiophanate-methyl, benomyl, carbendazim, cypendazole, debacarb, mecarbinzid, diethofencarb, climbazole, imazalil, oxpoconazole, prochloraz, triflumizole, imidazole compounds, azaconazole, bromuconazole, cyproconazole, diclobutrazol, difenoconazole, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, metconazole, myclobutanil, penconazole, propiconazole, prothioconazole, quinconazole, simeconazole, tebuconazole, tetraconazole, triadimefon, triadimenol, triticonazole, uniconazole, uniconazole-P, triazole compounds, Bordeaux mixture, Burgundy mixture, Cheshunt mixture, copper acetate, copper carbonate, basic, copper hydroxide, copper naphthenate, copper oleate, copper oxychloride, copper sulfate, copper sulfate, basic, copper zinc chromate, cufraneb, cuprobam, cuprous oxide, mancopper, oxine copper, famoxadone, fluoroimide, chlozolinate, dichlozoline, iprodione, isovaledione, myclozolin, procymidone, vinclozolin, captafol, captan, ditalimfos, folpet, thiochlorfenphim, binapacryl, dinobuton, dinocap, dinocap-4, dinocap-6, dinocton, dinopenton, dinosulfon, dinoterbon, DNOC, azithiram, carbamorph, cufraneb, cuprobam, disulfiram, ferbam, metam, nabam, tecoram, thiram, ziram, dazomet, etem, milneb, mancopper, mancozeb, maneb, metiram, polycarbamate, propineb, zineb, cyazofamid, fenamidone, fenapanil, glyodin, iprodione, isovaledione, pefurazoate, triazoxide, conazole compounds (imidazoles), potassium azide, potassium thiocyanate, sodium azide, sulfur, copper compounds, inorganic mercury compounds, mercuric chloride, mercuric oxide, mercurous chloride, (3-ethoxypropyl)mercury bromide, ethylmercury acetate, ethylmercury bromide, ethylmercury chloride, ethylmercury 2,3-dihydroxypropyl mercaptide, ethylmercury phosphate, N-(ethylmercury)-p-toluenesulphonanilide, hydrargaphen, 2-methoxyethylmercury chloride, methylmercury benzoate, methylmercury dicyandiamide, methylmercury pentachlorophenoxide, 8-phenylmercurioxyquinoline, phenylmercuriurea, phenylmercury acetate, phenylmercury chloride, phenylmercury derivative of pyrocatechol, phenylmercury nitrate, phenylmercury salicylate, thiomersal, tolylmercury acetate, aldimorph, benzamorf, carbamorph, dimethomorph, dodemorph, fenpropimorph, flumorph, tridemorph, ampropylfos, ditalimfos, edifenphos, fosetyl, hexylthiofos, iprobenfos, phosdiphen, pyrazophos, tolclofosmethyl, triamiphos, decafentin, fentin, tributyltin oxide, carboxin, oxycarboxin, chlozolinate, dichlozoline, drazoxolon, famoxadone, hymexazol, metazoxolon, myclozolin, oxadixyl, vinclozolin, barium polysulfide, calcium polysulfide, potassium polysulfide, sodium polysulfide, furametpyr, penthiopyrad, boscalid, buthiobate, dipyrithione, fluazinam, fluopicolide, pyridinitril, pyrifenox, pyroxychlor, pyroxyfur, bupirimate, cyprodinil, diflumetorim, dimethirimol, ethirimol, fenarimol, ferimzone, mepanipyrim, nuarimol, pyrimethanil, triarimol, fenpiclonil, fludioxonil, fluoroimide, ethoxyquin, halacrinate, 8-hydroxyquinoline sulfate, quinacetol, quinoxyfen, benquinox, chloranil, dichlone, dithianon, chinomethionat, chlorquinox, thioquinox, ethaboxam, etridiazole, metsulfovax, octhilinone, thiabendazole, thiadifluor, thifluzamide, methasulfocarb, prothiocarb, ethaboxam, silthiofam, anilazine, amisulbrom, bitertanol, fluotrimazole, triazbutil, conazole compounds (triazoles), bentaluron, pencycuron, quinazamid, acibenzolar, acypetacs, allyl alcohol, benzalkonium chloride, benzamacril, bethoxazin, carvone, chloropicrin, DBCP, dehydroacetic acid, diclomezine, diethyl pyrocarbonate, fenaminosulf, fenitropan, fenpropidin, formaldehyde, furfural, hexachlorobutadiene, iodomethane, isoprothiolane, methyl bromide, methyl isothiocyanate, metrafenone, nitrostyrene, nitrothal-isopropyl, OCH, 2-phenylphenol, phthalide, piperalin, probenazole, proquinazid, pyroquilon, sodium orthophenylphenoxide, spiroxamine, sultropen, thicyofen, tricyclazole, iodophor, silver, Nystatin, amphotericin B, griseofulvin, and zinc naphthenate.

SUBSTRATES: The invention provides for treatments of substrates. Substrates include fomites, including but not limited to:
Foot apparel, including shoes (including but not limited to sneakers, running shoes etc., boots, sandals, moccasins, slippers, etc), materials inserted within the shoe (including insoles, orthotics, linings, etc.) or other “foot coverings” (including socks, stockings, etc). Included are all shoes made from different types of materials, including leather, other animal skins, wood and wood derivatives, fabric, or other material (natural, synthetic, or semisynthetic) subject to fungal contamination.
Other substrates where squames/skin cells or hair or nails or the keratin protein of these structures are found, including those places where people take off or put on shoes or other footwear or other apparel or where the skin of humans (ex. feet) or other mammals who harbor fungal organisms may come into contact.
A floor, or covering thereof, including carpet, tile, mat, etc. found in homes, hospitals, gyms, swimming pools, saunas, airports or other public places.
Apparel which is worn on or comes in direct or indirect contact with skin including pants, shirt, gloves, underwear, diapers, coats, and hats. This list should not be construed as limiting, as any apparel is contemplated for treatment in the present invention.
Bedding, including but not limited to, bedding selected from the group consisting of sheets, blankets, pillow, pillow cases, mattresses, and bedsprings. This list should not be construed as limiting, as any bedding is contemplated for treatment in the present invention. Bedding includes any item that contacts the skin, directly or indirectly, in a bed.
Furniture, including but not limited to, substrates selected from the group consisting of a couch, a chair, a bed, or any piece of furniture covered in any material (including but not limited to leather, fabric, vinyl, carpets, mats, etc.) subject to fungal contamination. This list should not be construed as limiting, as any furniture is contemplated for treatment in the present invention.
Animal and kennel items including animal bedding including pet bedding, livestock bedding (including straw). Pet bedding can be selected from the following list, but any animal is contemplated including a dog, cat, pig, bird, and reptile. Livestock bedding can be selected from the group consisting of bedding for bovinas, equinas, pigs, sheep, goats and birds. This list should not be construed as limiting, as any bedding is contemplated for treatment in the present invention.
The substrate can be selected from the group consisting of articles worn or otherwise in contact with animals. These items include but are not limited to leashes, fomites, bridles, halters, horseshoes, animal apparel, and all other substrates and articles that directly or indirectly contact an animal's epidermis.
The substrate can also be a human or animal grooming device selected from the group consisting of combs, brushes, picks, razors, and cutters. This list should not be construed as limiting, as any grooming device is contemplated for treatment in the present invention.
All substrates, including those above, that come in direct or indirect contact with the epidermis of an animal are part of this invention.

DELIVERY METHODS: The following delivery methods are included in this invention, but the list should be construed as limiting:
Aerosol
Spray
Fog
Powder
Wipes
Insertion
Impregnation of the substrate with the antifungal compound

Each delivery system can be used either prior to contamination with the fungus, or post contamination.

### DETAILED DESCRIPTION

Fungal diseases are some of the most common affecting mammals, and include some of the most common infections in man. In humans these include, but are not limited to:

a) Tinea corporis—(“ringworm of the body”). This infection causes small, red spots that grow into large rings almost anywhere on the arms, legs, chest, or back.

b) Tinea pedis—fungal infection of the feet. Typically, the skin between the toes (interdigital tinea pedis or “Athlete's foot”) or on the bottom and sides of the foot (plantar or “moccasin type” tinea pedis) may be involved. Other areas of the foot may be involved. The infections may spread to the toenails (tinea unguium or onychomycosis) where it causes the toenails to become thick and crumbly. It can also spread to the hands and fingernails.

c) When the fungus grows in the moist, warm area of the groin, the rash is called tinea cruris. The common name for this infection is “jock itch.” Tinea cruris generally occurs in men, especially if they often wear athletic equipment.

d) Tinea capitis, which is called “ringworm of the scalp” causes itchy, red areas, usually on the head. The hair is often destroyed, leaving bald patches. This tinea infection is most common in children.

e) Dandruff, which is the excessive shedding (exfoliation) of the epidermis of the scalp. A fungus may cause, or aggravate, the condition.

The list above providing but a few of the most common of a long list of such diseases in one mammal. Many diseases caused by fungi have been identified, and also include such common disease as oral thrush and diaper rash. Fungi are often a complicating factor in diabetic and obese patients. In addition, disease in humans is caused by other fungi including but not limited to those from the genus Aspergillus, Blastomyces, Candida, Coccidioides, Cryptococcus, Histoplasma, Paracoccidioides, Sporothrix, and at least three genera of Zygomycetes, as well as those mentioned below under animals.

Secondary infections that can worsen diaper rash include fungal organisms (for example yeasts of the genus Candida).

In pets and companion animals the above fungi, as well as many other fungi, can cause disease. The present teaching is inclusive of substrates that contact animals directly or indirectly. Examples of organisms that cause disease in animals include Malassezia furfur, Epidermophyton floccosum, Trichophyton mentagrophytes, Trichopyton rubrum, Trichophyton tonsurans, Trichophyton equinum, Dermatophilus congolensisl, Microsporum canis, Microsporum audouini, Microsporum gypsium, Malassezia ovale, Pseudallescheria, Scopulariopsis and Candida albicans.

The present teachings include methods for treating a substrate that, directly or indirectly, contacts an epidermis including: a) treating a substrate with a first antifungal compound, and b) treating a substrate with a second antifungal compound. This treatment can occur at any time and includes treatment during manufacture of the substrate or the material that makes up the substrate, as well as treatment prior to or after contamination with a fungus or bacteria.

Decontamination of the apparel of individuals can reduce fungal contact with the epidermis. This in turn can reduce initial fungal contamination rate, and reduce re-contamination rates for affected individuals. In the case of Athlete's foot, treatment of the feet and the apparel can reduce the re-contamination rate and result in a more enduring cure of Athlete's Foot. This same paradigm is true for many fungal contaminations. For example, white line disease in horses (often caused by a fungal contamination of the hoof) can be passed through bedding, and recontamination of the same horse, or another, from bedding and/or the stall in which they are kept. Treatment of substrates with antifungal compounds could lead to decreased rates of contamination/infection and re-contamination/re-infection.

It is also true that treatment prior to contamination can reduce contamination rates, and treatment of apparel prior to washing can lead to a reduction in the passage of one infective unit from one piece of apparel to another.

The method provides for treating a substrate. This treatment involves contacting a substrate with the fungicidal compound in any manner (delivery methods are provided). The substrate can be selected from any substrate that directly or indirectly contacts an epidermis. For example, items that contact an epidermis directly include horse bedding contacting the horse hoof, or dog bedding contacting the hair protruding through the epidermis of the dog. Substrates that directly or indirectly contact a human epidermis can be widely varied as discussed in the definition of substrate.

In a further aspect the method includes a first and a second antifungal compound that are applied in a single application or in separate applications. Specific antifungal compounds are not limited to any particular type or class of antifungal compounds. Although specific antifungal compounds are discussed herein these are only presented as examples and should not be construed as limiting.

Direct contact of the epidermis includes all apparel that directly contacts the epidermis.

A further aspect includes antifungal compounds that can be used in the method wherein the antifungal compound is selected from the group of known antifungal compounds, or classes of compounds including naturally occurring compounds (including botanicals).

The above lists should not be construed as limiting as any and all antifungal compounds are contemplated in the present invention.

A further aspect includes antifungal compounds in the method wherein at least one of the first and second antifungal compound is a naturally occurring antifungal compound.

In addition, the inventors have shown for the first time that certain antifungal compounds have antibacterial properties. This is particularly useful when treating certain substrates that are susceptible to growth by both types of organisms.

In another aspect, a method for pre-treating a substrate that, directly or indirectly, contacts an epidermis comprising treating the substrate with an antifungal compound prior to use by the product's end user is provided. This can be done through any delivery method.

Combining agents has been suggested to have a number of potential benefits, including: (a) extending and broadening the spectrum of activity of the individual agents used, (b) increase the antimicrobial potency of individual compounds, (c) reduce the development of resistance, (d) treat resistant strains and (e) reduce the concentration used for at least one treatment agent, and (f) have anti-sporicidal activity with or without activating the spores. The data in the Examples herein shows that using a combination of the synthetic, semi synthetic, and natural products will achieve these objectives.

For example, since miconazole, unlike terbinafine and tolnaftate, possesses antibacterial activity, combining it with either agent will expand the spectrum of activity of disinfectant to cover dermatophytes, yeasts, and bacteria. In addition, because miconazole is a static agent against fungi, combining it with either terbinafine or tolnaftate, which we showed have fungal sporicidal activity, will expand the killing activity of the combination. These combinations are provided as examples and one of skill in the art can deduce from these teachings other effective combinations that can work synergistically.

In addition, we describe compositions that limit growth of odor causing bacteria, and the bacteria that cause cellulitis. The addition of these compounds to a treatment or pre-treatment composition will lead to advantageous synergistic effects including limiting foot odor and cellulitis while treating fungal contamination. In a preferred embodiment the composition contains a mixture of synthetic antifungal compounds and naturally occurring antifungal compounds (e.g. terbinafine or tolnaftate and lemongrass oil or terbinafine or tolnaftate lemongrass oil.). The inventors also have determined that the use of bactericidal compounds alone (including naturally occurring compounds, including but not limited to clove bud, lemongrass, and sandalwood oils) to treat bacteria alone would also be advantageous (e.g. treating or pre-treating substrates with bactericidal compounds). The advantages of treating with bactericidal compounds include, but are not limited to, decreased odor from the substrate.

Provided herein are newly discovered properties of compounds which include antibacterial, antifungal, and sporicidal properties. Also novel are the combinations of compounds which provide unexpected results in the treatment and pre-treatment of substrates against common fungi,(dermatophytes, yeasts, etc.) and bacteria. The inventors show for the first time that combining naturally occurring fungicides with known fungicides leads to unexpectedly good results and they also show that uses of naturally occurring fungicidal compounds, and for the first time, expands their utility against bacteria. It was concluded by the inventors that: 1) essential oils (especially lemongrass and clove bud oils) can be used singly as natural products to inhibit microorganisms that infect substrates and 2) combining essential oils with a synthetic antifungal compound will provide a broad spectrum activity. In addition to treating common microorganisms, they can be used to treat drug resistant microorganisms such as terbinafine resistant Trichophyton rubrum and multi-drug resistant Candida, as well as allow the use of lower concentrations of synthetic agents when combined with essential oils. Our method identified disinfectant methods and regimens that have potent antifungal and antibacterial activity and provides an effective means for preventing and treating fungal contamination of substrates (i.e. all substrates described herein), including but not limited to, shoes.

Having shown that antifungal compounds possess potent anti-dermatophyte activity, the inventors also showed the activity of these agents against dermatophytes using bioassays. These results show that treatment, and pretreatment, of substrates can lead to novel, unexpected results and provide manufacturers and consumers with novel techniques and compositions for controlling bacteria, fungi, dermatophytes and other unwanted microorganisms on substrates (including, but not limited to, shoes).

The use of particular excipients (detergents, oils, etc.) can also function in the invention to increase the penetration of the substrate, the rate of penetration, the thoroughness of coverage, etc. These can also be used to cause the penetration of a spore by an antifungal or antibacterial compound. Excipients can also be used to cause the spore to end dormancy and begin germination, thus making the spore more susceptible to the compounds.

The composition comprising the antifungal or antibacterial compound can also include a compound to increase adherence to the substrate. Increasing adherence to the substrate can increase the length of time for which the compound remains in contact with the substrate.

Aspects of the present teachings may be further understood in light of the following examples, which should not be construed as limiting the scope of the present teachings.

### EXAMPLES

### Example 1

### Examples of Antifungal Compounds that Function in the Invention

The treatment in this example consists of at least two antifungal compounds. Typical compounds are listed by their general class, chemical or otherwise. Concentrations pertain to the class. They are stated as an overall range. One would select at least one compound from each group of antifungal compounds described above or below and create a mixture of the two or more compounds. All percents indicate weight/volume.
IMIDAZOLES (0.01-10%): bifoconazole, butoconazole, clotrimazole, econazole, fluconazole, itraconazole, ketoconazole, miconazole, oxiconazole, saperconazole, sertaconazole, sulconazole, terconazole, tioconazole, voriconazole, ioloconazole
ALLYLAMINES AND BENZYLAMINES (0.001-10%; 0.05-5%): butenafine, naftifine, terbinafine.
POLYENES (0.01-10%; 0.5-5%): amphotericin B, candidicin, filipin, fungimycin, nystatin.
MISCELLANEOUS SYNTHETIC ANTIFUNGAL COMPOUNDS (for example at 0.05-25%): amorolfine (demethymorpholine), cicloprox olamine, haloprogen, clioquinol, tolnaftate, undecylenic acid, hydantoin, chlordantoin, pyrroInitrin, salicylic acid, ticlatone, triacetin, griseofulvin, zinc pyrithione.
DISINFECTANTS (for example at 0.001-20%): copper sulfate, Gentian Violet, betadyne/povidone iodine, colloidal silver, zinc.
BOTANICALS (for example at 0.01-10%): Basil (Oncimum basilicum), Cassia (Cinnamomum aromaticum var. cassia), Cedrus wood oil (Cedrus libani or Cedrus spp)., Chamomile (Chamaemelum nobile), Citronella (Cymbopogon nardus), Clove (Syzgium aromaticum), Cumin (Cuminum cyminum), Fennel (Foeniculum vulgare), MenthThe/Mint (MenthThe x piperita/MenthThe spicata), Tea Tree Oil (Melaleuca alternfolia), Tumeric leaf oil (CurcumThe longa), Lemongrass Oil (Cymbopogon citratus).

### Example 2

### Application Methods for Mixtures of Antifungal Compounds

It is known, for example, that Athlete's foot, once cured by appropriate antifungal compounds on the skin, reoccurs when the feet are re-infected by the same contaminated footwear. The inventors have shown that treatment of shoe materials with antifungal compounds and combinations of antifungal compounds can lead to unexpectedly good results in treatment of Athlete's foot. This treatment can be either a treatment of the substrate in contact with the foot prior to contamination (or use) or post contamination with fungus or bacteria. In a preferred embodiment at least one of the natural oils describes herein as effective in treatment of bacteria is used in the composition in order to limit fungal growth while at the same time limiting foot/shoe odor and cellulitis.

In addition treatment of various other substrates can also help break the cycle of Athlete's foot infections (infected feet, treated feet, reinfection of feet by untreated/contaminated footwear or other substrates) including treatment of flooring.

### Example 3

### Treatment for Military Apparel

A typical use of the invention will be to disinfect military socks, combat boots, and/or other apparel thus breaking the cycle of Athlete's foot re-contamination by contaminated footwear and clothing. The net effect will be a soldier relatively free from the itching and discomfort of that disease and/or other fungal contaminations. In this application boots, socks, and/or apparel is sprayed or soaked in antifungal compounds in at least a antifungal compounds solution, or created from substrates previously treated at the producer or manufacturer. All types and users of footwear and clothing are contemplated as users of this invention, but military clothing, footwear, and other apparatus are particularly prone to carry contamination since they are often worn for long periods. And as such are embodiments of the invention.

### Example 4

### Treatment for Flooring and Rugs/Mats

A typical use of the invention will be to decontaminate the rugs commonly found near swimming pools or in gyms, locker rooms (e.g. near locker room showers) and yoga classes. Since fungi thrive in warm, wet places, the rugs can be cleared of the infectious organisms that cause ringworm and Athlete's foot. These substrates will be treated using fungicidal compositions of the invention after use has begun or prior to being put in place (e.g. at the manufacturer) in order to limit the growth of fungi on them.

The treatment of substrates on/in the flooring are also contemplated at places such as gyms, security checkpoints in airports, and other places where people regularly remove their shoes.

### Example 5

### Treatment for Animal Substrates

The disinfectant kills or disables disease-causing fungi and fungus-like organisms in or on articles worn by animals, thus preventing contamination and re-contamination of their coat, skin, nails, hoofs, and similar structures by that means.

The diseases include superficial dermatological contaminations such as ringworm, rain rot, muck itch, girth itch, white line, and thrush. Articles worn by animals that are substrates for treatment include, but are not limited to, leashes, bridles, cinches, saddles, blankets, booties, fomites, and horseshoes.

A typical use of this invention is to decontaminate the underside of saddles or saddle blankets, thus preventing contamination and re-contamination of equine ringworm. Another expected use of the invention is to decontaminate the straw. This treatment will to prevent contamination and re-contamination by the myriad disease-causing fungi which dwell within.

### Example 6

### Evaluation of the Activity of Synthetic Antifungal Compounds and Natural Substances Against Microorganisms Infecting Shoes Using In Vitro and Shoe and Insole Biopsy Disc Assays

The shoe disinfecting activities of the following compounds were studied: terbinafine, tolnaftate, miconazole, Cedrus oil, and tea tree oil, clover bud oil, lemongrass oil, sandalwood oil and spearmint oil.

In Vitro Susceptibility Testing

Determination of Minimum Inhibitory Concentration (MIC) and Minimum Fungicidal Concentration (MFC)

Minimum Inhibitory Concentration (MIC): Minimum inhibitory concentrations of synthetic and natural products against dermatophytes were determined using a modification of the Clinical Laboratory Standards Institute (CLSI, formerly National Committee of Clinical Laboratory Standards, NCCLS) M38A standard method for dermatophytes developed at the Center for Medical Mycology (1) while MIC of these agents against Candida species were determined using the CLSI M27-A2 methodology (2). The method used to determine the MIC against bacteria was based on the CLSI document M7-A7 (3).

For dermatophytes, serial dilutions of terbinafine, tolnaftate were prepared in a range of 0.004-2 μg/ml, while for miconazole concentrations ranged between 0.015-8 μg/ml. Finally, for essential oils, the concentrations tested were between 0.03-16 μg/ml. The only exception was tea tree oil where dilutions were prepared in a range of 0.0078-4 μg/ml, The MIC was read at 4 days and defined as the lowest concentration of an agent to inhibit 80% of fungal growth as compared to the growth control (Table 2).

To determine the MIC of agents against Candida species, serial dilutions of terbinafine and tolnaftate were prepared in a range of 0.125-64 μg/ml, miconazole in a range of 0.03-16 μg/ml and tea tree oil had a range between 0.125-4 μg/ml. The remaining essential oils were prepared in a dilution range of 0.03-16 μg/ml. For Candida the MIC was read at 24 hours and defined as the lowest concentration to inhibit 50% of fungal growth as compared to the growth control (Table 4).

For bacterial species, the medium used to evaluate the antifungal and antibacterial activity of antifungal agents and essential oils were RPMI1640 (Hardy Diagnostics Santa Maria, Calif.) and Mueller-Hinton (Oxoid Ltd., Basingstoke, Hampshire, England), respectively. Serial dilutions of miconazole, terbinafine, and tolnaftate were prepared in a range of 0.125-64 μg/ml and serial dilutions of tea tree oil were prepared in a range of 0.0078-4 μg/ml, while those for the rest of the essential oils were prepared in a range 0.031-16 μg/ml. The MIC was read at 16 h and defined as the lowest concentration to inhibit 80% of bacterial growth compared to the growth control (Table 5).

Minimum fungicidal concentration (MFC): The minimum fungicidal concentrations of various agents were determined using the technique described earlier by Canton et al. (4). In this method, fungal conidia were collected following growth on potato dextrose agar (PDA) plates and were used to inoculate 96-well plates containing different concentrations of agents. Following incubation at 35° C. for 4 days (for dermatophytes) or 24 hours (for yeast), wells showing no visible growth were cultured to determine the MFC (defined as the lowest concentration of a given agent that kills 99-100% of fungal conidia or spores). The MFC value represents the level of the agent at which spores or conidia were killed.

Evaluation of the activity of combination of antifungal agents and essential oils against microorganisms infecting shoes:

Combining agents has been suggested to have a number of potential benefits, including: (a) extending and broadening the spectrum of activity of the individual agents used, (b) increase the antimicrobial effectiveness of individual compounds, (c) reduce the development of resistance, (d) treat resistant strains and (e) reduce the concentration used for at least one treatment agent, and (f) have sporicidal activity (5).

Bioassay

The shoe substrate used in this study was Dr Scholl's© air pillow insoles. We selected this substrate to use in our bioassay because we showed earlier that this insole has no inhibitory activity against dermatophytes (see below), and is representative of the type of material used in manufacturing shoe insoles.

To evaluate the ability of the agents to prevent and treat fungal contamination of insoles and leather, we determined their activity against the dermatophyte T. mentagrophytes, and developed novel insole/leather biopsy assays. T. mentagrophytes was used as the model strain in our bioassay studies because this fungus is a major cause of tinea pedis and onychomycosis. Unlike T. rubrum, which is often identified as the causative organism in these diseases but is a poor producer of spores/conidia, T. mentagrophytes, in addition to being an etiological agent of these diseases, produces conidia reproducibly and therefore, is amenable for use in a bioassay. It is expected that activity in this assay against T. mentagrophytes will be indicative of activity against T. rubrum and other dermatophytes.

Development of a Shoe Bioassay.

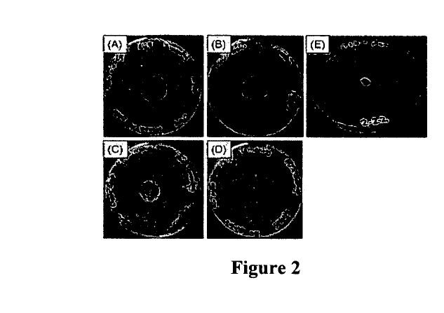

To evaluate the shoe disinfecting ability of various agents, it was necessary to develop a bioassay method. Our aim was to develop an assay that has utility in determining the activity of different agents to prevent (through pre-treatment) and treat (through post-treatment) contamination on shoes. The first step in the bioassay development was to identify optimal insole and leather material that represent substrates used in shoes and that do not inhibit fungi by themselves. To select the optimal shoe insole, discs measuring 8 mm were cut using a Dermal Biopsy punch (Miltex, Bethpage, N.Y.) from four commercially available shoe insoles (CVS odor stop insoles, Dr Scholl's air pillow insoles [which claim antifungal activity], odor eater insoles, and CVS double air foam insoles). These biopsy discs were placed on T. mentagrophytes seeded PDA plates. T. mentagrophytes was used as a typical organism and is representative of an entire class of fungi that grows on/in shoes and other substrates. The ability of insole biopsy discs from existing products to inhibit dermatophytes, following incubation for 7 days at 35° C., was determined. Our data showed that three of the insoles (CVS Odor Stop, Odor Eater, and CVS Double Air Foam) had a minimal antifungal activity (FIG. 2A-C) while Dr Scholl's insole did not inhibit T. mentagrophytes at all (FIG. 2D). Similar approach was used to determine whether biopsy discs from the leather hide we obtained inhibit fungal growth. Our data showed that the leather material did not have any antifungal activity by itself (FIG. 2E). Therefore, Dr Scholl's insole and the leather hide were used as substrates in subsequent experiments.

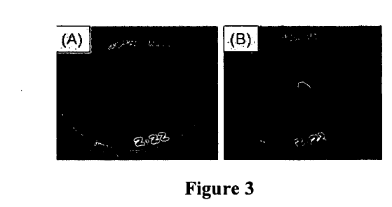

In our bioassay, we decided to use isopropanol as a vehicle to dissolve the various disinfectants. We selected this solvent because it is a common solvent used in different preparations marketed for the treatment of tinea pedis. We next performed experiments to identify a concentration of isopropanol that did not inhibit fungal growth by itself. The ability of three different concentrations (30%, 50%, and 100%) of isopropanol to inhibit dermatophyte growth was tested. Our data showed that 30% isopropanol was the optimal concentration at which the vehicle did not inhibit fungal growth on the insoles and leather surface (FIG. 3A-B). In some experiments, because tolnaftate does not dissolve very well in isopropanol, we performed additional experiments using acetone as a vehicle.

Based on the above experiments, our disc biopsy assay employed Dr. Scholl's insole and leather discs as the optimal substrates representing materials used in shoes, and 30% isopropanol as the optimal vehicle to dissolve the agents to be tested in pre-treatment and post-treatment studies.

Evaluation of the Ability of Various Agents to Prevent and Treat Fungal Shoe Contamination.

Two types of disc biopsy assays were used to evaluate the ability of different synthetic and natural substances to disinfect shoe material: (a) Pre-treatment assay: Where discs were pre-treated with antifungals first and then infected with T. mentagrophytes, and (b) Post-treatment assay: where discs were first infected with T. mentagrophytes, then treated with drugs. These assays will reveal the ability of different agents to prevent and treat shoe fungal contamination, respectively.

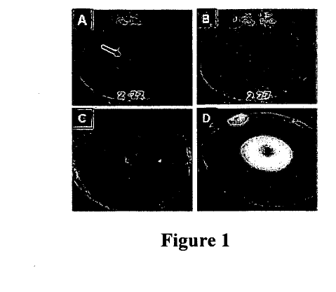

Pre-treatment assays: To evaluate the ability of different agents to prevent fungal contaminations of shoes, PDA plates were prepared on which 10⁴ T. mentagrophytes cells were evenly spread. Next, discs from insoles and leather were treated as follows (with either agent or control vehicle): discs were pretreated with a single spray, spraying for 15 second or 30 second. Other discs were immersed in agent or vehicle for 30 min. Following this treatment, discs were air-dried by placing them in a Petri plate for 1 min. These dried discs were then placed (drug side down) on the seeded PDA plates. Plates were then incubated for 4 days at 30° C. Following incubation, fungal growth was recorded. Active agents showed a clearance zone around the biopsy disc (FIG. 1A, arrow), while inactive agents showed fungal growth all around the disc (FIG. 1B). Diameter of the clearance zone (CZD) was measured. The relative activity of different agents and control were assessed. In this assay, active agents had higher CZD than inactive or less active ones.

Post-treatment assays: To evaluate the ability of various agents to treat infected shoes, PDA plates were prepared on which 10⁴ T. mentagrophytes cells were evenly spread on their surface. Next, untreated biopsy discs were placed on these PDA plates and incubated for 4 days at 30° C. Incubating the biopsy discs in this manner allowed the fungi to invade the discs. Infected discs were picked and post-treated with different agents by spraying. Post-treated discs were allowed to air dry and were then placed on fresh, uninoculated PDA plates and incubated for 4 additional days at 30° C. Incubation of the discs under these conditions allows any fungi that are not killed by the sprayed agent to grow. In other words, agents that are effective in the treatment of shoe material will not show any fungal growth around the disc biopsy (FIG. 1C). In contrast, discs treated with ineffective agents will show fungal growth emanating from them (FIG. 1D). Diameter of the growth zone (GZD) was determined as a measure of the activity of the agent tested. In this assay, inactive or less active agents had higher GZD than active agents, while active agents did not show any fungal growth (GZD=0).

Scanning Electron Microscopy (SEM).

Scanning electron microscopy (SEM) was used to monitor the ability of agents to eradicate fungal growth on shoe insoles or leather biopsy discs. Pre- and post-treated discs were processed for SEM by the method of Chandra et al. as described earlier (6). One set of discs was used as a control in which no drug pre- or post-treatment was performed. In addition, one set of biopsy discs was used as blank where no fungal cells or drug were added. Following treatment, discs were fixed with 2% glutaraldehyde for 2 h, and then washed with sodium cacodylate buffer (three times for 10 minutes each). The discs were then treated with 1% osmium tetraoxide (for 1 h at 4° C.) followed by a series of washing with sodium cacodylate buffer, followed by a two times washing with distilled water. Next, the discs were treated with 1% tannic acid washed three times with distilled water, and followed by 1% uranyl acetate with two water washings. The samples were then dehydrated through a series of ethanol solutions (range from 25% (vol/vol) ethanol in distilled water to absolute ethanol). Prepared samples were then sputter coated with Au/Pd (60/40) and viewed with Amray 1000B scanning electron microscope.

### Results

In Vitro Susceptibility Testing

Minimum Inhibitory Concentration (MIC) and Minimum Fungicidal

Concentration (MFC)

Evaluation of the inhibitory activity of various agents showed that these agents were effective in inhibition of dermatophytes, yeasts and bacteria to varying degrees. Data from these MIC/MFC studies are summarized in Table 1 (for details of the MIC/MFC data, please see Tables 2-5) Summary of the antifungal and antibacterial activity of different synthetic and natural products tested is summarized below.

Antimicrobial Activity of Synthetic Agents:

Terbinafine: Our results showed that terbinafine was highly active against all isolates of the three dermatophytes genera tested where low MIC values were noted (MIC range=0.008-0.06 μg/mL). In addition, this agent was able to kill spores of these dermatophytes as demonstrated by low MFC values (MFC range was between 0.03-0.125 μg/mL). Evaluation of the anti-yeast activity of terbinafine showed that this agent possesses high activity against all C. parapsilosis isolates tested (MIC values for all isolates was 0.25 μg/mL). In this regard, C. parapsilosis is a known skin normal flora inhabitant. Our data showed that terbinafine was less active against C. albicans compared to C. parapsilosis with one to three fold higher MIC values against the majority of isolates tested relative to C. parapsilosis (MIC values for 5 strains ranged between 0.5 and-2 μg/mL). Interestingly, terbinafine exhibited no effect against one C. albicans strain (strain 8280 where the MIC was >64 μg/mL). In contrast to the high activity of terbinafine seen against dermatophytes and yeast strains, this agent did not show any antibacterial activity against all bacterial strains examined (MIC>64 μg/mL for all strains tested).

Tolnaftate: Evaluation of the antifungal activity of tolnaftate showed that this agent is highly active against the dermatophytes tested both in fungal inhibition (MIC range against all dermatophytes tested was 0.008-0.125 μg/mL) and spore killing (MFC range was 0.06-0.125 μg/mL). Tolnaftate inhibitory and sporicidal activity was similar to terbinafine or slightly (one dilution) higher. Evaluation of the anti-yeast activity of tolnaftate showed that this agent has a reduced activity against yeast compared to terbinafine. Elevated MICs for tolnaftate was observed against all C. albicans strains tested (MIC value for all strains was ≧64 μg/mL). While activity of tolnaftate against C. parapsilosis was strain-dependent with one strain (# 7629) showing low MIC (0.5 μg/mL), while the other isolates exhibited relatively high MIC values (MIC=8-16 μg/mL). Susceptibility testing of bacteria to tolnaftate showed that this agent had no S. aureus antibacterial activity (MIC for all strains tested was >64 μg/mL), while possessing some strain-dependent activity against S. epidermidis strains: two strains had MIC values of 2 μg/mL, while the remaining four exhibited MICs ranging between 16 and >64 μg/mL.

Miconazole: Susceptibility testing of dermatophytes against miconazole showed that this agent possesses a potent antifungal activity against T. mentagrophytes, T. rubrum, and E. floccosum with MIC values ranging from 0.06 to 0.125 μg/mL. Compared to terbinafine and tolnaftate, miconazole had a slightly lower activity. Moreover, unlike these agents, miconazole was static against dermatophytes. (MFC of miconazole against all T. mentagrophytes isolates and the majority of T. rubrum and E. floccosum isolates tested was ≧8 μg/mL). Our data show that miconazole possesses a modest anti-yeast activity. In general, the MIC values of miconazole against both C. albicans and C. parapsilosis were higher than those obtained for terbinafine. C. albicans showed some strain-dependent susceptibility against miconazole, with an MIC=1-2 μg/mL for four isolates, 16 μg/mL for another and ≧16 μg/mL for the remaining albicans strain (8280). MIC values of miconazole against C. parapsilosis were also strain dependent (MICs ranging from 4 to ≧16 μg/mL). In contrast to terbinafine and tolnaftate (which had no activity against bacteria), miconazole was active against both S. aureus and S. epidermidis isolates tested (MIC values against all Staphylococcus isolates were between 0.5 and 2 μg/mL).

Cedrus oil: Antifungal susceptibility testing of Cedrus oil showed that this natural oil possessed acceptable antifungal activity against dermatophytes in vitro with MIC ranging between 0.5 and 2 μg/mL. In addition, Cedrus oil exhibited species-dependent cidality: MFC against T. mentagrophytes was noticeably higher (MFC=4-16 μg/mL) than against E. floccosum, and T. rubrum isolates (MFC=0.5-4 μg/mL). Results are detailed in Table 1.

Tea Tree Oil: Antifungal susceptibility testing of dermatophytes against tea tree oil showed that this natural product is highly active in inhibiting and spore killing of these fungi (MIC₅₀=0.125-0.4, while MFCs were =0.25 to >4 μg/mL against all dermatophytes tested). Moreover, the MIC and MFC values of tea tree oil against dermatophytes were lower than those noted for Cedrus oil. A majority of the yeast isolates were resistant to tea tree oil (MIC>4 μg/mL). Interestingly, one C. albicans isolates (8280) was susceptible to tea tree oil, although the same isolate was resistant to terbinafine, tolnaftate, and miconazole (with an MIC of 64, >64, and >16 μg/mL, respectively). This finding is very interesting because it indicates that combining tea tree oil with any of the three agents may provide enhanced shoe disinfecting activity, suggesting that adding tea tree oil to any of the antifungals may provide a broad coverage against resistant isolates (MIC>4 μg/mL). The possibility of combining tea tree oil with different agents against this resistant fungus was evaluated (see below). The bacterial strains tested were not susceptible to tea tree oil. Results are detailed in Table 1.

### Results

Antimicrobial activity of all effective essential oils against dermatophytes known to grow on feet, causing tinea pedis, yeasts known to cause nail infection, and bacteria that can cause foot infection or generate unpleasant odor.

C.1.2. Activity Against Dermatophytes:

In these studies we evaluated the activity of essential oils against dermatophytes, yeast and bacteria. Table 7 presents a summary of the anti-dermatophyte activity of essential oils. As can be seen, the five essential oils tested exhibited potent antifungal activity against dermatophytes with MICs ranging between 0.125 and 0.5 μg/mL.

C.1.2. Activity Against Yeast:

Next we tested the ability of these oils to inhibit yeast (C. albicans and C. parapsilosis). As can be seen in Table 8, four of the essential natural oils (clover bud, lemongrass, spearmint, and tea tree oils) were active against these clinically important fungi, with MIC range between 0.063-0.5 μg/mL. The only exception was sandalwood oil, which had an MIC of 4 to >16 μg/mL (Table 3). These results suggested that sandalwood oil exhibited no inhibitory activity against Candida species and strains tested.

C.1.3. Activity against Bacteria:

We next tested the in vitro activity of the essential natural oils against: (a) odor-producing (Micrococcus and Corynebacteria) bacteria, and (b) Staphylococcus aureus (a major cause of cellulitis). As seen in Table 9, clove bud, lemongrass, and sandalwood oils were active against the odor-producing bacteria tested (MIC=0.25-2 μg/mL), while spearmint and tea tree oils did not show in vitro activity (MIC=2-8 μg/mL). Furthermore, clove bud, lemongrass, and sandalwood oils showed some activity (MIC=0.25-8 μg/mL) against Staphylococcus. Moreover, lemongrass tended to have one to two dilutions lower MIC than clove and sandalwood oils, indicating it is more active. In contrast, spearmint and tea tree oil did not show noticeable activity against any of the pathogenic bacterial isolates tested (MIC=8-32 μg/mL). These studies showed that clove bud and lemongrass had the broadest antimicrobial activity compared to the other essential oils and are viable candidate for use as natural products to treat shoes.

D.1. Evaluation of the Activity of Combination of Antifungal Agents and Essential Oils Against Microorganisms Infecting Shoes:

To assess the potential for using antifungal synthetic agents (e.g. terbinafine, tolnaftate and miconazole) and essential oils (e.g. clove bud, lemongrass, sandalwood, spearmint and tea tree oil) in combination, we evaluated the ability of essential oils to inhibit terbinafine-resistant T. rubrum and C. albicans strain (strain number MRL 8280) that exhibits multi-resistance to terbinafine, miconazole and tolnaftate. As shown in Table 10, all the terbinafine-resistant T. rubrum isolates tested were susceptible to the essential natural oils, with an MIC range of 0.031 to 0.25 μg/mL. The most potent oil was lemongrass which showed very low MICs against these Trichophyton isolates.

Similarly, the essential oils were effective in inhibiting the multi-resistant C. albicans strain. The most effective essential oil in inhibiting this resistant strain was lemongrass (see Table 11).

### D. CONCLUSIONS

Based on these data it is concluded that: 1) essential oils (especially lemongrass and clove bud oils) can be used singly as natural products to inhibit microorganisms that infect shoes. 2) combining essential oils with a synthetic antifungal provides a broad spectrum activity, treats terbinafine resistant Trichophyton rubrum, and multi-drug resistant Candida, as well as allows the use of lower concentrations of synthetic agents when combined with essential oils. Our method identified disinfectant “systems” that have potent antifungal and antibacterial activity and provides an effective means for preventing and treating fungal contaminations of shoes and other substrates.

Having shown that terbinafine, tolnaftate, and essential oils possess potent anti-dermatophyte activity against microorganisms that colonize and infect the foot using in vitro susceptibility assays, we next investigated the activity of these agents against dermatophytes using the shoe disc bioassay we developed, and SEM techniques.

Effect of Pretreatment of Shoe Insoles and Leather Surfaces with Synthetic and Natural Products on Preventing Dermatophyte Shoe Contamination

Pretreatment of Insoles

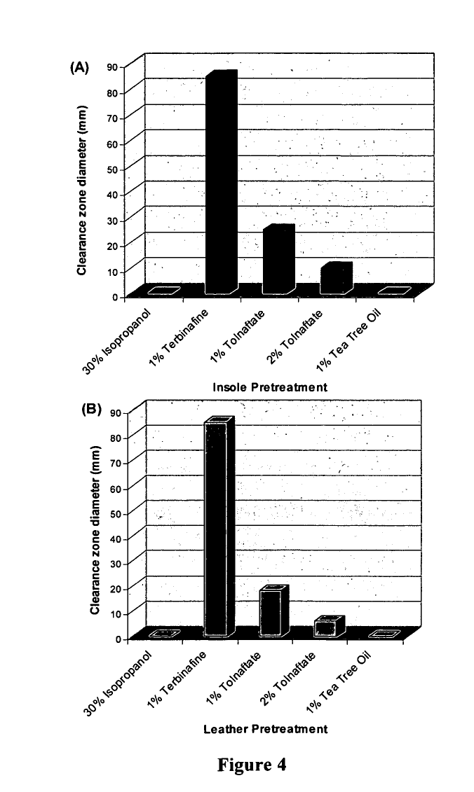

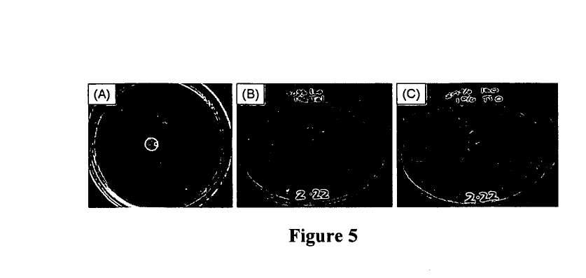

To determine the ability of terbinafine, tolnaftate, and tea tree oil to prevent shoe contamination we used the pretreatment insole biopsy bioassay method described above. As shown in FIG. 4 (and Table 11, representative images in FIG. 5), pretreatment of insoles with terbinafine 1% solution resulted in complete inhibition of fungal growth (CZD=85 mm, fungal inhibition reached to the edge of the Petri dish) compared to vehicle control (CZD=0 mm). This complete inhibition was observed even when the insoles discs were pretreated with a single spray. Pre-treatment of biopsy discs with tolnaftate (1% and 2%) also inhibited fungal growth (CZD=25 mm and 11 mm, respectively) compared to vehicle control, albeit to a lesser extent than terbinafine. Because tolnaftate dissolves better in acetone, we repeated some experiments using acetone as a vehicle. Our data showed that tolnaftate has a potent preventive activity against dermatophytes infecting shoes (FIG. 5). Increasing the concentration of tolnaftate to 3% and 4% increased the activity. In contrast, 1% tea tree oil had no inhibitory prevention effect (CZD=0 mm). Taken together, these data show that pretreatment of shoe insoles and leather material with terbinafine or tolnaftate is an effective way to prevent fungal contamination of shoes. Importantly, these agents were superior to the marketed Dr. Scholl's brand in preventing fungal contamination of insoles.

Pretreatment of Leather

To determine whether pretreatment of leather biopsy discs with terbinafine, tolnaftate, or tea tree oil can prevent growth of T. mentagrophytes, we tested their activity using the bioassay method described above. As shown in FIG. 4B, pretreatment of leather disc with vehicle did not result in any inhibition (CZD=0 mm), while terbinafine pretreatment resulted in complete inhibition of fungal growth (CZD=85 mm, also see Table 6). Pretreatment of leather biopsies with 1% tolnaftate resulted in inhibition of fungal growth (CZD=16 mm, FIG. 4B). However, pretreatment of leather disc with 1% tea tree alone oil did not inhibit fungal growth (CZD=0 mm).

These data indicate that pre-treatment of leather material with terbinafine or tolnaftate is an effective way for preventing fungal contamination of the leather used in shoes.

Effect of Post-Contamination Treatment with Synthetic and Natural Products on Eradication of Pre-Established Dermatophyte Contamination on Insoles and Leather Surfaces

Ability of Agents to Treat Insoles Infected with Dermatophytes

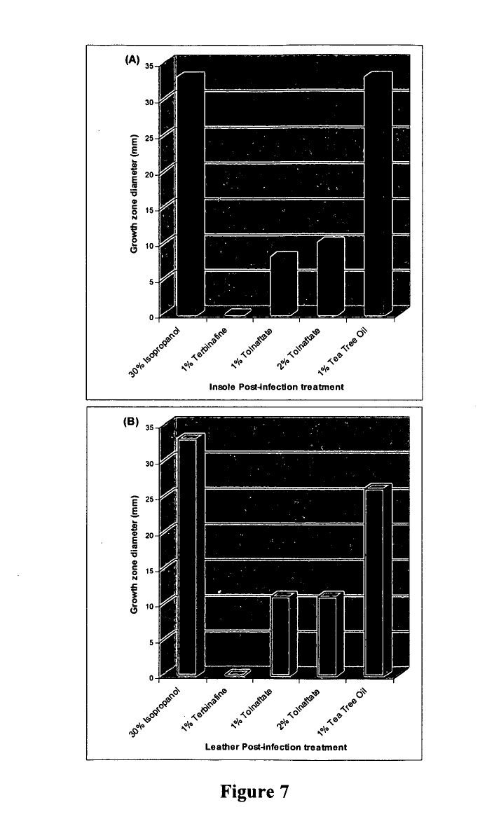

To determine the ability of terbinafine, tolnaftate, or tea tree oil to treat T. mentagrophytes contamination already established on shoe insoles, we determined the effect of post-treating infected insoles with these agents on their ability to clear the established fungal contamination using our post-treatment shoe biopsy disc assay developed (see above). As shown in FIG. 7A (and Table 6), while the vehicle control failed to treat already established fungal contamination as evidenced by the presence of fungal regrowth (GZD=33 mm of growth), terbinafine completely eradicated established contamination on insoles (GZD=0 mm). Tolnaftate (both 1% and 2%) were also effective in clearing the contamination of insole, although some minimal regrowth was observed (GZD=8 mm and 10 mm, respectively). In contrast, tea tree oil was not able to treat the contamination present on insole biopsies (GZD=33 mm).

Post Contamination Treatment of Leather

Next, we determined whether terbinafine, tolnaftate, or tea tree oil can treat T. mentagrophytes contamination already established on leather biopsy discs. As shown in FIG. 7B (and Table 6), terbinafine completely cleared the established contamination on leather disc (GZD=0 mm). Moreover, tolnaftate (1% and 2%) also reduced contamination of leather (GZD=11 mm for both concentrations). Tea tree oil induced very minimal inhibition of fungal growth on the infected leather biopsies compared to vehicle control (GZD=26 mm versus 33 mm). These data clearly demonstrate that post treatment of insoles and leather with terbinafine and tolnaftate is an effective way for treating infected shoes.

Effect of Combination of Tolnaftate and Tea Tree Oil on Preventing Dermatophyte Shoe Contamination

To determine whether using combination of synthetic compounds and essential oils will allow the use of low concentrations of synthetic drugs, we tested the ability of combination of 0.01% tolnaftate and 3% tea tree oil to prevent shoe contamination using the pre- and post-treatment insole bioassays described above.

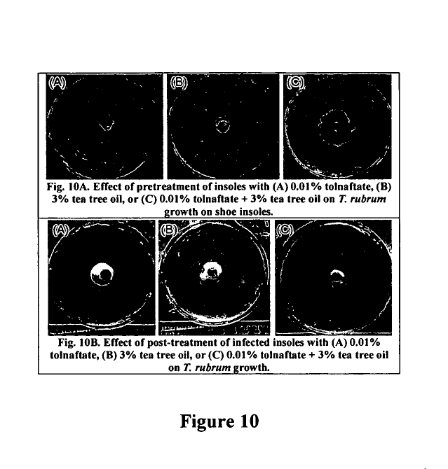

As shown in FIG. 10, pretreatment of insoles with 0.01% terbinafine or 3% tea tree oil singly did not result in any inhibition of fungal growth. In contrast, the combination of 0.01% terbinafine and 3% tea tree oil induced a noticeable inhibition of fungal growth (FIG. 10C).

Furthermore, while 0.01% tolnaftate or 3% tea tree oil did not prevent growth of fungus on insole after post-treatment (FIG. 10A (A)-(B), post-contamination treatment with the combination of these agents reduced fungal growth (FIG. 10A (C).

These data show that combining tolnaftate and tea tree oil will allow the use of low concentration of tolnaftate to prevent and treat shoe contamination.

Scanning Electron Microscopy Analyses

SEM of Pre-Treated and Post-Treated Insoles

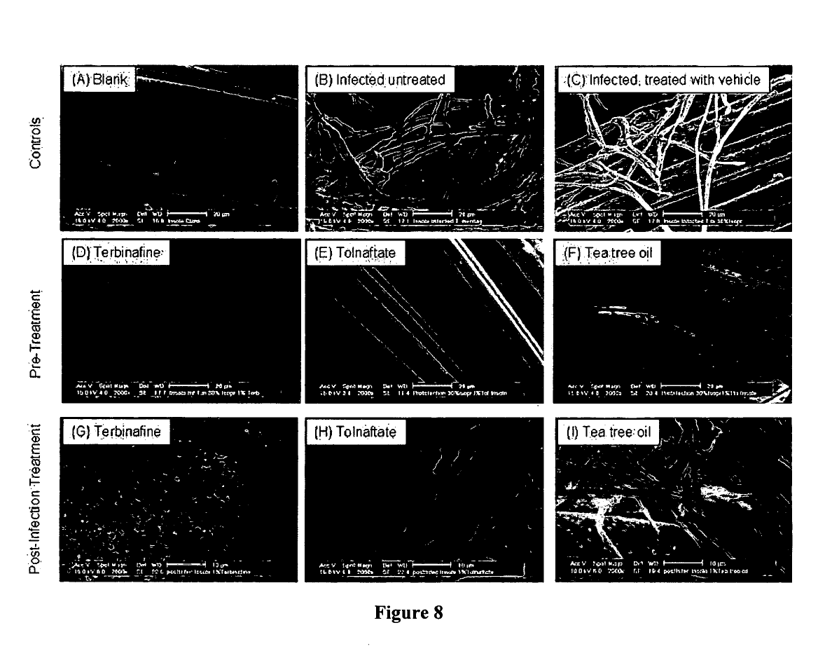

To determine the effect of synthetic and natural products (pre- and post-contamination treatments) on the ability of T. mentagrophytes to grow on insole biopsies, we performed SEM analysis. As shown in FIG. 8, pretreatment of insole with the vehicle had no effect on fungal growth (FIG. 8C), while terbinafine and tolnaftate completely eradicated fungal growth (FIG. 8D,E; no fungal elements were seen). However, and similar to the bioassay studies, pretreatment with tea tree oil reduced the fungal growth on insoles but did not eliminate it from the biopsy disc (FIG. 8F). Post-contamination treatment of insole with terbinafine resulted in complete clearance of fungal growth (FIG. 8G), while treatment with tolnaftate was minimally effective, as shown by the presence of several filaments (FIG. 8H). In contrast, post-contamination treatment with tea tree oil had no activity against T mentagrophytes (FIG. 8I).

These data show that pre- and post-treatment with terbinafine is highly effective in eradicating fungal elements from shoe material infected with T. mentagrophytes. Additionally, tolnaftate was effective in eradicating fungal elements only if insole biopsies were pretreated with this agent.

Taken together, these data indicate that pre- and post-treatment of insoles with either terbinafine or tolnaftate is effective in preventing the fungal colonization of, and treatment of already existing, fungal growth on insoles.

Our data also demonstrate that combining tolnaftate and tea tree oil will allow the use of low concentration of tolnaftate to prevent and treat shoe contamination

SEM Analysis of Pre-Treated Leather Biopsy Discs

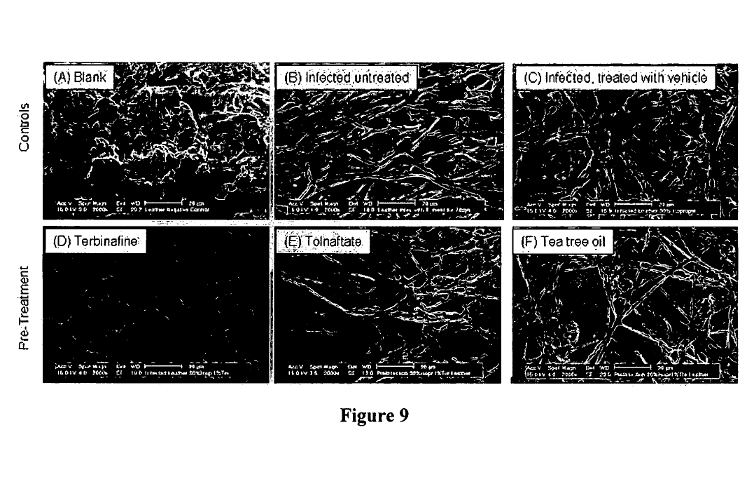

We used SEM analyses to determine the effect of terbinafine, tolnaftate and tea tree oil pretreatment on their ability to prevent T. mentagrophytes growth on leather biopsies. As shown in FIG. 9, pretreatment of leather biopsy disc with terbinafine completely eradicated fungal growth, where no fungal elements were seen (FIG. 9D), compared to untreated leather disc (FIG. 9B) or vehicle-treated disc (FIG. 9C), where massive fungal elements can be seen invading the leather material. Pretreatment with tolnaftate appeared to reduce the fungal density on leather discs, but did not completely eradicate dermatophyte growth (FIG. 9E). Discs pre-treated with tea tree oil did not show any effect on fungal growth (FIG. 9F), and were similar in appearance to the discs pretreated with isopropanol, the vehicle control.

Taken together, these results revealed that pre-treatment of leather with terbinafine was highly effective in preventing and eradicating fungal elements from leather material infected with T. mentagrophytes, while tolnaftate was minimally effective. In contrast, tea tree oil was ineffective in eradicating contamination of leather discs. Post-contamination treatment of leather with terbinafine, tolnaftate, and tea tree oil is currently being performed.

Our findings show that:

Among the synthetic agents tested (terbinafine, tolnaftate, miconazole):

The most active agent inhibiting dermatophytes was terbinafine, followed by tolnaftate and miconazole.

Terbinafine and tolnaftate were able to kill dermatophytes fungal spores that may be present in shoes, while miconazole is static against dermatophyte spores.

Terbinafine and miconazole were also effective against the yeast Candida species, but in a strain- and species-dependent manner.

Miconazole exhibited activity against bacterial species, while tolnaftate exhibited strain-dependent inhibition of S. epidermidis.

Among the natural products tested (tea tree oil, Cedrus oil, clove bud, lemongrass oil, Sandalwood Oil, Spearmint Oil).

3. Our findings show that:

Essential oils have a broad antimicrobial activity covering dermatophytes, yeast and bacteria that infect shoes. The most active essential oils were lemongrass followed by clove bud.

Essential oils possess inhibitory activity against bacteria that produces unpleasant odors and Staphylococcus aureus (a major cause of cellulitis).

The essential natural oils have potent in vitro activity against terbinafine-resistant dermatophytes, as well as multi-resistant C. albicans. Lemongrass possesses the most potent activity in this regard.

In bioassay studies, terbinafine and tolnaftate pretreatment were able to inhibit fungi on insoles and leather shoe biopsies compared to vehicle control. Terbinafine was the most active pre-treatment agent.

Terbinafine post-treatment was able to treat established fungal contamination on shoe biopsy discs. Although tolnaftate showed antifungal activity as a post-treatment agent, its activity was less than that of terbinafine. Tea tree oil was ineffective as a post-treatment agent.

Combining a synthetic antifungal agent with an essential oil allows the use of low doses of the synthetic antifungal to prevent and treat infected shoe insole.

Our data indicate that combining agents is likely to provide benefit by expanding the spectrum of activity of a disinfectant through the inhibition of resistant fungal strains.

In conclusion, the invented disinfectant has potent antifungal and antibacterial activity and provides an effective means for preventing and treating fungal contaminations of shoes and other substrates.

TABLE 1
Range of MICs (μg/ml) and MFCs (μg/ml) of Terbinafine, Tolnaftate,
Miconazole, Tea Tree Oil and Cedrus Oil against Dermatophytes, Yeasts and Bacteria

| | Terbinafine | Tolnaftate | Miconazole | Tea tree oil | Cedrus oil |
|---|---|---|---|---|---|
| Organism | (μg/ml) | (μg/ml) | (μg/ml) | (μg/ml) | (μg/ml) |
| All Dermatophytes | | | | | |
| MIC Range | 0.015 | 0.125 | 0.015-0.25 | 0.0625-0.25 | 0.25-1.0 |
| MFC Range | 0.03-0.125 | 0.06-1.0 | 0.5->8.0 | 0.125->2 | 0.5-8 |
| All Yeasts | | | | | |
| MIC range | 0.25->64 | 0.5->64 | 1->16 | 0.125->2 | ND* |
| MFC range | — | — | 0.5-2 | — | ND* |
| All Bacteria | | | | | |
| MIC range | >64 | 2->64 | 0.5-2 | >4 | ND* |
| MFC range | — | — | — | — | ND* |

*ND - not determined

TABLE 2
Minimum Inhibitory Concentration (MIC, μg/mL) and Minimum Fungicidal
Concentration (MFC, μg/mL) of Terbinafine, Tolnaftate, and Miconazole Against
Dermatophytes

| | TERBINAFINE | | TOLNAFTATE | | MICONAZOLE | |
|---|---|---|---|---|---|---|
| Organism | MIC | MFC | MIC | MFC | MIC | MFC |
| E. floccosum | | | | | | |
| 1666 | 0.06 | 0.06 | 0.06 | 0.25 | 0.125 | 2 |
| 1798 | 0.03 | 0.03 | 0.06 | 0.25 | 0.125 | 0.5 |
| 1925 | 0.03 | 0.06 | 0.06 | 0.25 | 0.06 | 8 |
| 1926 | 0.06 | 0.06 | 0.125 | 0.5 | 0.125 | >8 |
| 1961 | 0.06 | 0.125 | 0.125 | 0.5 | 0.125 | >8 |
| 2165 | 0.06 | 0.125 | 0.06 | 0.25 | 0.125 | >8 |
| MIC Range (n = 6) | 0.03-0.06 | 0.03-0.125 | 0.06-0.125 | 0.25-0.5 | 0.06-0.125 | 0.5->8 |
| MIC₅₀ | 0.06 | 0.06 | 0.06 | 0.25 | 0.125 | 8 |
| MIC₉₀ | 0.06 | 0.125 | 0.125 | 0.5 | 0.125 | >8 |
| T. rubrum | | | | | | |
| 1967 | 0.015 | 0.125 | 0.015 | 0.06 | 0.125 | 8 |
| 2098 | 0.015 | 0.06 | 0.015 | 0.06 | 0.125 | 4 |
| 2246 | 0.008 | 0.06 | 0.008 | 0.06 | 0.125 | 1 |
| 8063 | 0.015 | 0.06 | 0.008 | 0.06 | 0.125 | 8 |
| 8071 | 0.015 | 0.06 | 0.015 | 0.06 | 0.25 | 8 |
| 8092 | 0.015 | 0.03 | 0.015 | 0.125 | 0.25 | 8 |
| MIC Range (n = 6) | 0.008-0.015 | 0.03-0.125 | 0.008-0.015 | 0.06-0.125 | 0.125-0.25 | 1-8 |
| MIC₅₀ | 0.015 | 0.06 | 0.015 | 0.06 | 0.125 | 8 |
| MIC₉₀ | 0.015 | 0.125 | 0.015 | 0.125 | 0.25 | 8 |
| T. mentagrophytes | | | | | | |
| 1720 | 0.004 | ND* | 0.008 | ND | 0.03 | ND |
| 2124 | 0.03 | 0.125 | 0.06 | 0.5 | 0.25 | >8 |
| 2125 | 0.03 | 0.125 | 0.06 | 0.5 | 0.25 | >8 |
| 2126 | 0.004 | ND | 0.004 | ND | 0.015 | ND |
| 2127 | 0.03 | 0.06 | 0.06 | 1 | 0.25 | >8 |
| 2128 | 0.03 | 0.125 | 0.125 | 1 | 0.125 | >8 |
| MIC Range (n = 6) | 0.004-0.03 | 0.06-0.125 | 0.008-0.125 | 0.5-1 | 0.015-0.25 | >8->8 |
| MIC₅₀ | 0.03 | 0.125 | 0.06 | 0.5 | 0.25 | >8 |
| MIC₉₀ | 0.03 | 0.125 | 0.125 | 1 | 0.125 | >8 |
| All dermatophytes | | | | | | |
| MIC Range (n = 18) | 0.008-0.015 | 0.03-0.125 | 0.008-0.125 | 0.06-1 | 0.015-0.25 | 0.5->8 |
| MIC₅₀ | 0.03 | 0.06 | 0.06 | 0.125 | 0.125 | 8 |
| MIC₉₀ | 0.06 | 0.125 | 0.125 | 1 | 0.25 | >8 |

*ND = Not Determined

TABLE 3
Minimum Inhibitory Concentration (MIC, μg/mL) and Minimum
Fungicidal Concentration (MFC, μg/mL) of Cedrus Oil and Tea Tree Oil
against Dermatophytes

| | Cedrus Oil | | Tea Tree Oil | |
|---|---|---|---|---|
| Organism | MIC | MFC | MIC | MFC |
| E.floccosum | | | | |
| 1666 | 0.5 | 2 | 0.25 | 2 |
| 1798 | 0.25 | 1 | 0.25 | 1 |
| 1925 | 0.5 | 1 | 0.5 | 2 |
| 1926 | 0.5 | 1 | 0.5 | 2 |
| 1961 | 1 | 4 | 0.5 | 2 |
| 2165 | 0.5 | 4 | 0.5 | 1 |
| MIC Range (n = 6) | 0.25-1 | 1-4 | 0.25-0.5 | 1-2 |
| MIC₅₀ | 0.5 | 1 | 0.5 | 2 |
| MIC₉₀ | 1 | 4 | 0.5 | 2 |
| T. rubrum | | | | |
| 1967 | 0.5 | 2 | 0.25 | 2 |
| 2098 | 0.5 | 2 | 0.5 | 2 |
| 2246 | 0.5 | 0.5 | 0.5 | 1 |
| 8063 | 1 | 2 | 0.5 | 2 |
| 8071 | 1 | 4 | 0.5 | 4 |
| 8092 | 1 | 2 | 0.5 | 2 |
| MIC Range(n = 6) | 0.5-1 | 0.5-4 | 0.25-0.5 | 1-4 |
| MIC₅₀ | 0.5 | 2 | 0.5 | 2 |
| MIC₉₀ | 1 | 4 | 0.5 | 2 |
| T. mentagrophytes | | | | |
| 1720 | 0.25 | ND | 0.25 | >4 |
| 2124 | 2 | 8 | 0.125 | 4 |
| 2125 | 1 | 16 | 0.25 | 4 |
| 2126 | 0.25 | ND | 0.25 | >4 |
| 2127 | 0.5 | 8 | 0.25 | 4 |
| 2128 | 0.5 | 4 | 0.25 | 4 |
| MIC Range (n = 6) | 0.25-2 | 4-16 | 0.125-0.25 | 4- >4 |
| MIC₅₀ | 0.5 | 8 | 0.25 | 4 |
| MIC₉₀ | 0.5 | 16 | 0.25 | >4 |
| All dermatophytes | | | | |
| MIC Range (n = 18) | 0.5-2 | 1-16 | 0.125-0.5 | 0.25- >4 |
| MIC₅₀ | 0.5 | 2 | 0.25 | 2 |
| MIC₉₀ | 1 | 8 | 0.5 | 4 |

TABLE 4
Minimum Inhibitory Concentration (MIC, μg/mL) of Terbinafine,
Tolnaftate, Miconazole, and Tea Tree Oil against Candida species.

| | | | | TEA |
|---|---|---|---|---|
| | TERBINAFINE | TOLNAFTATE | MICONAZOLE | TREE OIL |
| STRAIN | MIC | MIC | MIC | MIC |
| C. albicans | | | | |
| 1740 | 1 | >64 | 1 | >4 |
| 2108 | 0.5 | 64 | 2 | >4 |
| 2153 | 0.5 | >64 | 1 | >4 |
| 8280 | >64 | >64 | >16 | 0.25 |
| 8283 | 0.5 | >64 | 16 | 0.5 |
| 8364 | 2 | >64 | 2 | >4 |
| MIC Range (n = 6) | 0.5 − >64 | 64 − >64 | 1 − >16 | 0.25 − >4 |
| MIC₅₀ | 0.5 | >64 | 2 | >4 |
| MIC₉₀ | 2 | >64 | 16 | >4 |
| C. parapsilosis | | | | |
| 7629 | 0.25 | 0.5 | 4 | 0.25 |
| 7668 | 0.25 | 8 | 16 | >4 |
| 7672 | 0.25 | 8 | 8 | >4 |
| 7995 | 0.25 | 8 | 4 | >4 |
| 8148 | 0.25 | 8 | >16 | 2 |
| 8442 | 0.25 | 16 | 4 | >4 |
| MIC Range (n = 6) | 0.25-0.25 | 0.5-16 | 4->16 | 0.25->4 |
| MIC₅₀ | 0.25 | 8 | 4 | >4 |
| MIC₉₀ | 0.25 | 8 | 16 | >4 |
| All yeasts | | | | |
| MIC Range (n = 12) | 0.25->64 | 0.5->64 | 1->16 | 0.25->4 |
| MIC₅₀ | 0.25 | 16 | 4 | 22 4 |
| MIC₉₀ | 2 | >64 | >16 | >4 |

TABLE 5
Minimum Inhibitory Concentration (MIC, μg/mL) of Terbinafine,
Tolnaftate, Miconazole, and Tea Tree Oil against Staphylococcus species.

| | | | | TEA |
|---|---|---|---|---|
| | TERBINAFINE | TOLNAFTATE | MICONAZOLE | TREE OIL |
| STRAIN | MIC | MIC | MIC | MIC |
| S. aureus | | | | |
| 93 NON-VIABLE | NON-VIABLE | NON-VIABLE | NON-VIABLE | |
| 730 | >64 | >64 | 2 | >4 |
| 732 | >64 | >64 | 2 | >4 |
| 733 | >64 | >64 | 2 | >4 |
| 734 | >64 | >64 | 2 | >4 |
| 8470 | >64 | >64 | 2 | >4 |
| MIC Range (n = 6) | >64 | >64 | 2 | >4 |
| MIC₅₀ | >64 | >64 | 2 | >4 |
| MIC₉₀ | >64 | >64 | 2 | >4 |
| S. epidermidis | | | | |
| 8472 | >64 | 2 | 0.5 | >4 |
| 8473 | >64 | 16 | 1 | >4 |
| 8474 | >64 | 2 | 0.5 | >4 |
| 8475 | >64 | >64 | 1 | >4 |
| 8476 | >64 | >64 | 1 | >4 |
| 8477 | >64 | >64 | 1 | >4 |
| MIC Range (n = 6) | >64 | 2->64 | 0.5-1 | >4 |
| MIC₅₀ | >64 | 16 | 1 | >4 |
| MIC₉₀ | >64 | >64 | 1 | >4 |
| All bacteria | | | | |
| MIC Range (n = 12) | >64 | 2->64 | 0.5-2 | >4 |
| MIC₅₀ | >64 | >64 | 1 | >4 |
| MIC₉₀ | >64 | >64 | 2 | >4 |

TABLE 6
Effect of pretreatment and post-contamination treatment of leather and
insole biopsy discs with different agents on growth of T. mentagrophytes.

| | | Insoles | | |
|---|---|---|---|---|
| | | Post- | | Leather |
| | Insoles | contamination | Leather | Post-contamination |
| | Pretreatment | Treatment | Pretreatment | Treatment |
| Spray | (CZD*, mm) | (GZD*, mm) | (CZD, mm) | (GZD, mm) |
| 30% Isopropanol | 0 | 33 | 0 | 33 |
| 1% Terbinafine | 85 | 0 | 85 | 0 |
| 1% Tolnaftate | 25 | 8 | 18 | 11 |
| 2% Tolnaftate | 10 | 10 | 6 | 11 |
| 1% Tea Tree Oil | 0 | 33 | 0 | 26 |
| 1% Tol 1% TTO** | 11 | 17 | 11 | 20 |
| 2% Tol 1% TTO | 19 | 8 | 15 | 11 |
| 2% Tol 2% TTO | 10 | 34 | 0 | 30 |
| 3% Tol 1% TTO | 25 | 11 | 20 | 11 |

*CZD - clearance zone diameter; GZD - growth zone diameter.
**Tol - Tolnaftate; TTO - tea tree oil.

TABLE 7
Activity of essential oils against dermatophytes

| | | | | | | |
|---|---|---|---|---|---|---|
| | | Clove | Lemongrass | Sandalwood | Spearmint | Tea Tree |
| Organism | Species | Bud Oil | Oil | Oil | Oil | Oil |

| | | | | | | |
|---|---|---|---|---|---|---|
| Epidermophyton | floccosum | 0.125 | 0.25 | 0.5 | 0.5 | 0.5 |
| Epidermophyton | floccosum | 0.125 | 0.25 | 0.25 | 0.125 | 0.5 |
| Trichophyton | mentagrophytes | 0.125 | 0.5 | 0.25 | 0.25 | 0.25 |
| Trichophyton | mentagrophytes | 0.125 | 0.25 | 0.25 | 0.25 | 0.25 |
| Trichophyton | rubrum | 0.125 | 0.25 | 0.5 | 0.25 | 0.5 |
| Trichophyton | rubrum | 0.125 | 0.25 | 0.5 | 0.5 | 0.5 |

| | | | | | |
|---|---|---|---|---|---|
| MIC Range | 0.125-0.125 | 0.25-0.5 | 0.25-0.5 | 0.125-0.5 | 0.25-0.5 |
| MIC₅₀ | 0.125 | 0.25 | 0.25 | 0.25 | 0.5 |
| MIC₉₀ | 0.125 | 0.5 | 0.5 | 0.5 | 0.5 |

TABLE 8
Activity of essential natural oils against yeast Isolates

| | | Clove | Lemongrass | Sandalwood | Spearmint | Tea |
|---|---|---|---|---|---|---|
| Organism | Species | Bud Oil | Oil | Oil | Oil | Tree Oil |
| Candida | Albicans | 0.125 | 0.063 | >16 | 0.5 | 0.25 |
| Candida | Albicans | 0.125 | 0.25 | >16 | 2 | 1 |
| Candida | Albicans | 0.5 | 0.125 | >16 | 2 | 1 |
| Candida | Parapsilosis | 0.125 | 0.125 | 4 | 0.5 | 0.25 |
| Candida | Parapsilosis | 0.125 | 0.125 | >16 | 0.5 | 0.25 |
| Candida | Parapsilosis | 0.25 | 0.125 | >=16 | 1 | 0.25 |

| | | | | | |
|---|---|---|---|---|---|
| MIC Range | 0.125-0.5 | 0.063-0.25 | 4->16 | 0.5-2 | 0.25-1 |
| MIC₅₀ | 0.125 | 0.125 | >16 | 0.5 | 0.25 |
| MIC₉₀ | 0.5 | 0.25 | >16 | 2 | 1 |

TABLE 9
Activity of natural oils against (A) odor-causing and (B) pathogenic bacterial isolates

| | | | | | | |
|---|---|---|---|---|---|---|
| | | Clove Bud | Lemongrass | Sandalwood | | |
| MRL | | Oil MIC | Oil MIC | Oil MIC | Spearmint Oil | Tea Tree Oil |
| Number | Organism | (mg/mL) | (mg/mL) | (mg/mL) | MIC (mg/mL) | (mg/mL) |

(A) Odor causing bacteria

| | | | | | | |
|---|---|---|---|---|---|---|
| 781 | Corynebacterium sp. | 2 | 0.25 | 0.5 | 8 | 8 |
| 782 | Corynebacterium sp. | 1 | 0.25 | 0.25 | 4 | 2 |
| 783 | Micrococcus luteus | 0.5 | 0.5 | 0.25 | 4 | 2 |
| 784 | Micrococcus luteus | 0.5 | 0.25 | 0.5 | 2 | 4 |

| | | | | | |
|---|---|---|---|---|---|
| MIC Range(n = 4) | 0.5-2 | 0.25-0.5 | 0.25-0.5 | 2-8 | 2-8 |
| MIC₅₀ | 0.5 | 0.25 | 0.25 | 4 | 2 |
| MIC₉₀ | 2 | 0.5 | 0.5 | 8 | 8 |

(B) Pathogenic bacteria

| | | | | | | |
|---|---|---|---|---|---|---|
| 730 | S. aureus | 2 | 1 | 2 | 8 | 32 |
| 732 | S. aureus | 1 | 1 | 0.25 | 8 | NG |
| 733 | S. aureus | 1 | 0.5 | 0.5 | 8 | 8 |
| 8470 | S. aureus | 2 | 1 | 2 | 16 | 32 |

| | | | | | |
|---|---|---|---|---|---|
| MIC Range(n = 4) | 1-2 | 0.5-1 | 0.25-2 | 8-16 | 8-32 |
| MIC₅₀ | 2 | 1 | .25 | 8 | 32 |
| MIC₉₀ | 2 | 1 | >2 | 8 | >32 |

TABLE 10
Activity of natural oils against terbinafine-resistant T. rubrum isolates

| | | Terbinafine | Clove Bud | Lemongrass | Sandalwood | Spearmint | Tea Tree oil |
|---|---|---|---|---|---|---|---|
| Organism | MRL Number | MIC | oil MIC | oil MIC | oil MIC | oil MIC | MIC |
| T. rubrum | 666 | 16 | 0.25 | 0.063 | 2 | 2 | 4 |
| T. rubrum | 670 | 16 | 0.125 | 0.063 | 0.5 | 0.5 | 1 |
| T. rubrum | 671 | 4 | 0.125 | 0.063 | 1 | 0.5 | 1 |
| T. rubrum | 1386 | 4 | 0.125 | <=0.031 | 0.5 | 0.25 | 4 |
| T. rubrum | 1806 | 4 | 0.125 | <=0.031 | 0.5 | 0.25 | 0.5 |
| T. rubrum | 1807 | 4 | 0.125 | 0.063 | 0.5 | 0.5 | 4 |
| T. rubrum | 1808 | 16 | 0.125 | 0.25 | 0.5 | 0.5 | 2 |
| T. rubrum | 1809 | 16 | 0.25 | 0.125 | 2 | 2 | 4 |
| T. rubrum | 1810 | 4 | 0.063 | <=0.031 | 0.125 | 0.125 | 2 |
| T. rubrum | 2499 | 4 | 0.125 | 0.125 | 1 | 0.5 | 4 |
| T. rubrum | 2727 | 2 | 0.125 | <=0.031 | 0.25 | 0.125 | 1 |

| | | | | | | |
|---|---|---|---|---|---|---|
| MIC Range(n = 11) | 2-16 | 0.063-0.25 | <=0.031-0.25 | 0.125-1 | 0.125-2 | 0.5-4 |
| MIC₅₀ | 4 | 0.125 | 0.063 | 0.5 | 0.5 | 2 |
| MIC₉₀ | 16 | 0.25 | 0.125 | 2 | 2 | 4 |

TABLE 11
Activity of essential oils against a multi-resistant strain of C. albicans
(strain 8280).

| Essential Oil | MIC (μg/mL) |
|---|---|
| Clove Bud Oil | 0.125 |
| Lemongrass Oil | 0.063 |
| Sandalwood Oil | >16 |
| Spearmint Oil | 0.5 |

Other Embodiments

The detailed description set-forth above is provided to aid those skilled in the art in practicing the present invention. However, the invention described and claimed herein is not to be limited in scope by the specific embodiments herein disclosed because these embodiments are intended as illustration of several aspects of the invention. Any equivalent embodiments are intended to be within the scope of this invention. Indeed, various modifications of the invention in addition to those shown and described herein will become apparent to those skilled in the art from the foregoing description which do not depart from the spirit or scope of the present inventive discovery. Such modifications are also intended to fall within the scope of the appended claims.

All publications, patents, patent applications and other references cited in this application are incorporated herein by reference in their entirety for all purposes to the same extent as if each individual publication, patent, patent application or other reference was specifically and individually indicated to be incorporated by reference in its entirety for all purposes. Citation of the reference herein shall not be construed as an admission that such is prior art to the present invention.

What is claimed is:

1. A method for treating a substrate that, directly or indirectly, contacts an epidermis comprising: a) treating the substrate with a first antifungal compound, and b) treating the substrate with a second antifungal compound wherein the application process is selected from the group consisting of serially, simultaneously, or separately.

2. The method of claim 1 wherein said first antifungal compound and said second antifungal compound are applied in a single application.

3. The method of claim 1 wherein said first antifungal compound and said second antifungal compound are applied in separate applications.

4. The method of claim 1 wherein at least a third antifungal compound is applied to the substrate in an application, wherein the application process is selected from the group consisting of serially, simultaneously, or separately.

5. The method of claim 1 wherein the substrate is apparel.

6. The method of claim 5 wherein said apparel is a shoe.

7. The method of claim 5 wherein said apparel is a sock.

8. The method of claim 5 wherein said apparel is a pants, shirt, glove, underwear, diapers, coat, and hat.

9. The method of claim 1 wherein said substrate is bedding.

10. The method of claim 9 wherein said bedding is selected from a group consisting of sheets, blankets, pillows, pillow cases, mattresses, and bedsprings.

11. The method of claim 1 wherein said substrate is furniture.

12. The method of claim 11 wherein said furniture is selected from a group consisting of a couch, a chair, a bed, and a piece of furniture.

13. The method of claim 1 wherein said substrate is selected from the group consisting of animal bedding, straw, grooming devices, stalls, and cages.

14. The method of claim 13 wherein said animal bedding is selected from a group consisting of pet bedding and livestock bedding.

15. The method of claim 14 wherein said pet bedding is selected from a group consisting of bedding for a dog, cat, pig, bird, and reptile.

16. The method of claim 14 wherein said livestock bedding is selected from a group consisting of bedding for bovinas, equinas, pigs, sheep, goats, and birds.

17. The method of claim 13 where the grooming devices are selected from the group consisting of combs, brushes, picks, razors, and cutters.

18. The method of claim 1 wherein said substrate is selected from articles worn or otherwise in contact with animals.

19. The method of claim 18 wherein said article is selected from the group consisting of fomites, bridles, halters, horseshoes, and apparel.

20. The method of claim 1 wherein at least one of said first antifungal compound and said second antifungal compound is selected from a class of known antifungal compounds.

21. The method of claim 1 wherein at least one of said first antifungal compound and second antifungal compound is a naturally occurring antifungal compound(s).

22. The method of claim 21 wherein at least one of said first antifungal compound and second antifungal compound is a botanical antifungal compound(s).

23. A method for treating the substrate that, directly or indirectly, contacts an epidermis comprising: a) treating the substrate with the first antifungal compound, and b) treating the substrate with at least a second antifungal compound, wherein at least one of said first antifungal compound and said second antifungal compound is applied via an aerosol.

24. A method for treating a substrate that, directly or indirectly, contacts an epidermis comprising: a) treating the substrate with a first antifungal compound, and b) treating the substrate with at least a second antifungal compound, wherein at least one of said first antifungal compound and said second antifungal compound is applied via a delivery method.

25. A method for delivering one or more antifungal compound to a substrate wherein said system applies at least one of said first antifungal compound and said second antifungal compound via a fog, aerosol, spray, powder, wipe, insertion, or impregnation.

26. A method of claim 25 wherein at least one antifungal compound is naturally occurring.

27. A method for pre-treating a substrate that, directly or indirectly, contacts an epidermis comprising treating the substrate with one or more antifungal compound(s) prior to use by the product's end user.

28. A method of claim 27 wherein at least one antifungal compound is naturally occurring.

29. The method of claim 27 wherein said substrate is a shoe or shoe insole.

30. The method of claim 27 wherein said substrate is a sock.

31. A method of decreasing the LD50 of a compound with antifungal properties by combining said antifungal with a second compound wherein said second compound is a botanical antifungal compounds.

33. A method of claim 1 wherein the substrate is a shoe.

34. A method of claim 1 wherein the substrate comprises the floor of hospital, gym, or airport.

35. A method of claim 1 wherein at least one antifungal compound is selected for its ability to inhibit or kill spores.

36. A method of claim 35 wherein the antifungal compound is naturally occurring.

37. A method of claim 36 wherein the antifungal compound is botanical.

38. A method of claim 37 wherein the antifungal compound is selected from the group consisting of clove bud, lemongrass, and sandalwood oils.

39. A method of claim 38 wherein the substrate is shoes.

40. A method of claim 39 wherein the treatment is a pre-treatment.

42. A composition for treating shoes wherein the composition comprises about 0.01% tolnaftate and about 3% tea tree oil.

43. A composition for treating a substrate wherein the composition comprises less than 1% tolnaftate and greater than 1% tea tree oil.

44. A method of claim 1 wherein at least one antifungal compound is a bactericidal compound.

45. A method of claim 44 wherein the bactericidal compound is naturally occurring.

46. A method of claim 45 wherein the bactericidal compound is botanical.

47. A method of claim 46 wherein the bactericidal compound is clove bud, lemongrass, and sandalwood oils.

48. A method of applying an antifungal or antibacterial compound or mixture of at least a antifungal or antibacterial compounds of the invention which increases the susceptibility of spores by causing spore germination or increasing the penetration of the antifungal or antibacterial compound into the spore.

49. A method of claim 1 wherein the composition comprising the antifungal compound also includes a compound to increase adherence to the substrate.
